(19) United States
(12) Patent Application Publication
(10) Pub. No.: US 2020/0259232 A1
(43) Pub. Date: Aug. 13, 2020

(54) STABLE BATTERY WITH HIGH PERFORMANCE ON DEMAND

(71) Applicant: EC POWER, LLC, State College, PA (US)

(72) Inventors: Shanhai GE, State College, PA (US); Chao-Yang WANG, State College, PA (US)

(21) Appl. No.: 16/787,103

(22) Filed: Feb. 11, 2020

Related U.S. Application Data
(60) Provisional application No. 62/804,899, filed on Feb. 13, 2019.

(51) Int. Cl. H01M 10/6571; H01M 10/615; H01M 4/133; H01M 4/137; H01M 4/131

(52) U.S. Cl. CPC H01M 10/6571; H01M 10/615; H01M 4/131; H01M 4/137; H01M 4/133

(57) ABSTRACT

A battery cell is disclosed having an internal resistor configured to heat the battery cell via power from the battery cell to at least a performing state temperature (Tₚ). Such a battery cell includes one or more passivating elements to increase the charge-transfer resistance of the battery cell by at least 4 times relative to a battery cell without the one or more passivating elements.

### CROSS-REFERENCE TO RELATED APPLICATIONS

This application claims the benefit of U.S. Provisional Application No. 62/804,899 filed 13 Feb. 2019, the entire disclosure of which is hereby incorporated by reference herein.

### TECHNICAL FIELD

The present disclosure relates generally to rechargeable electrochemical energy storage cells. In particular, the present disclosure is directed to lithium ion batteries configured to achieve both high safety and high performance.

### BACKGROUND

Rechargeable lithium ion batteries are widely used in electrified vehicles, consumer electronics and stationary energy storage systems. Conventional batteries are passive devices where the performance, safety, and calendar/cycle life are all dictated by the electrochemical reactivity at ever-present anode/electrolyte and cathode/electrolyte interfaces. There exists an inherent conflict between the reactivity and stability of battery materials and hence the resulting electrode/electrolyte interface: highly reactive electrode/electrolyte materials provide high power and high performance but result in low safety and high degradation even when the battery is not in use. Highly stable (i.e. low-reactivity) electrode/electrolyte materials facilitate battery safety, low degradation, low self-discharge and long life, but such materials offer low power or performance when in use. As a result, materials development for batteries has concentrated on trade-offs of finding electrode and electrolyte materials that are not too reactive but also not too stable.

Both high performance and high safety cannot be simultaneously obtained by the traditional paradigm of battery science and technology. However, to meet an ever-increasing power demand, battery materials are currently designed to sacrifice stability and hence battery safety. Accordingly, there is a continuing need for rechargeable batteries having both high performance and high safety.

### SUMMARY OF THE DISCLOSURE

Advantages of batteries of present disclosure are high stability but with high performance when needed.

These and other advantages are satisfied, at least in part, by a battery having one or cells comprising an internal resistor configured to heat the battery cell via power from the battery cell to at least a performing state temperature (Tₚ). Advantageously, the one or more battery cells have one or more passivating elements which increase the charge-transfer resistance of the battery cell by at least 4 times relative to a battery cell without the one or more passivating elements. Charge-transfer resistances can be determined by electrochemical impedance spectroscopy when the battery cells are at 25° C. Such battery cells can be constructed with one or more passivating elements which include, for example: (a) one or more electrode active materials having a mean particle size larger than 20 μm, or (b) one or more electrode active materials with a Brunauer, Emmett and Teller (BET) surface area of 0.25 m²/g or less, or (c) a coating on one or more electrode active materials or (d) one or more electrode active materials with a dopant, or (e) one or more electrolyte additives that passivates one or more electrode active materials, (f) employing a high concentration salt in the electrolyte, or any combination thereof.

Another aspect of the present disclosure includes methods of operating a battery having one or more battery cells comprising an internal resistor configured to heat the battery cell via power from the battery cell to at least Tₚ. The methods include internally heating the battery cell to Tₚ when the battery cell has a temperature below Tₚ; and powering an external load via the battery cell while a temperature of the battery cell is at Tₚ or higher. The methods can further include cooling the battery cell below Tₚ. when the battery cell is not powering an external load.

Additional advantages of the present invention will become readily apparent to those skilled in this art from the following detailed description, wherein only the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent similar elements throughout and wherein:

FIG. 1 is a chart representing a trade-off between reactivity and stability of battery materials.

FIGS. 2A and 2B are plots graphically illustrating reactivity vs. time relation of a stable battery according to an embodiment of the present disclosure (FIG. 2A) compared to a conventional battery (FIG. 2B).

FIG. 3A illustrates a battery cell having an internal resistor configured to heat the battery cell to a temperature of at least Tₚ. in accordance with an implementation of the present disclosure.

FIG. 3B illustrates an electrical circuit for a stable battery according to embodiments of the present disclosure.

FIG. 4 is a plot of measured charge-transfer resistance of a comparative example battery and batteries prepared according to Examples 1 and 2.

FIG. 5 shows plots of cell voltage and temperature evolutions during nail penetration of a battery cell prepared according to Example 2 (plot on the right) vs. a comparative example battery cell (plot on the left). Both cells have a nominal capacity of 2.8 Ah in the form of pouch cells and comprise the same graphite anode and NMC622 cathode materials. Comparative example battery cell was prepared with a standard electrolyte: 1M LiPF₆ in EC/EMC (3/7 wt.)+2% VC. Example 2 battery cell was prepared with electrolyte of 1M LiPF₆ in EC/EMC (1/9 wt.)+2% VC+3% FEC+1% TAP.

FIG. 6A and FIG. 6B are plots showing direct current resistances (DCR) of discharge (FIG. 6A) and charge (FIG. 6B) at 50% state of charge for battery cells for the comparative example and Examples 1 and 2.

FIG. 7 is a plot of capacity retention of the comparative example battery cell and examples 1 and 2 battery cells during cycling at 60° C. Cycling conditions were 1 C charge to 4.2V CCCV till C/20 and then 1 C discharge to 2.8V.

### DETAILED DESCRIPTION

The present disclosure is directed to a new class of batteries in which the battery's safety and low degradation or long life are facilitated by using low-reactive, highly stable electrode and electrolyte materials, while the battery's high power is provided by increasing electrochemical activity through thermal stimulation when needed to power an external load, i.e., on demand. That is, battery material development for a stable battery according to the present disclosure concentrates on the stability of the battery; the higher the stability, the better. This is an opposite direction from conventional approaches to battery material design, in that conventional battery materials are designed to provide high reactivity to meet the ever growing need for higher power generation.

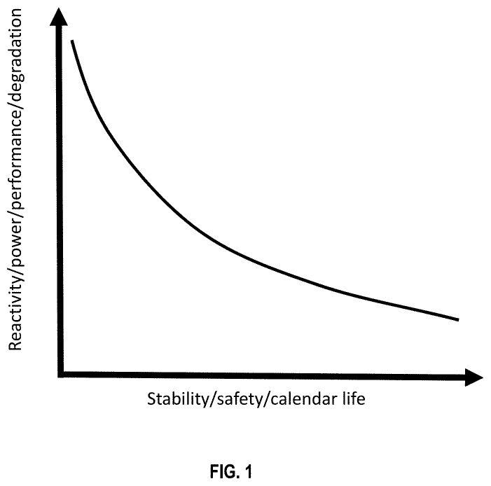

As explained in the Background section, there is an inherent conflict between reactivity and stability of any battery material (see FIG. 1). High reactivity gives rise to high power and high performance; but high reactivity also gives rise to high degradation of materials. On the other hand, high stability promotes high safety and long calendar life. Conventional batteries meet high power demand at the expense of battery safety.

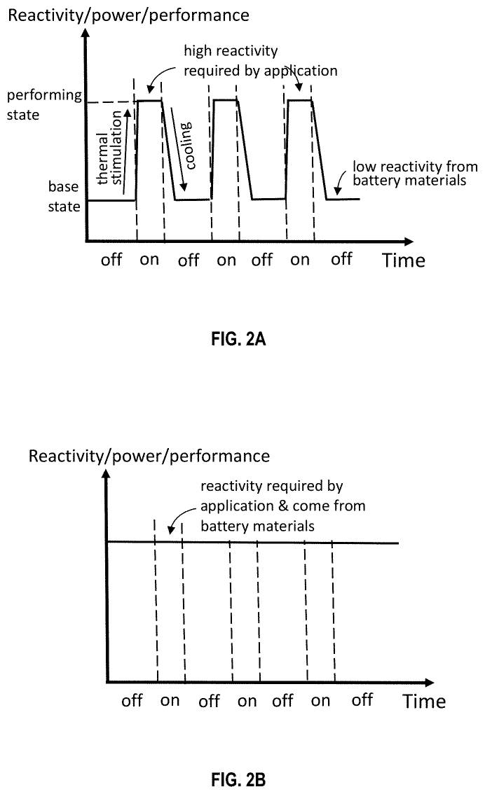

Advantageously, batteries of the present disclosure are configured to have high stability and high inherent safety by using materials with low reactivity at around ambient temperature, such as at 25° C. Such a design completely disrupts traditional paradigms of battery development. FIGS. 2 A and B illustrate the different approaches to battery material design for batteries of the present disclosure compare to a conventional battery.

As shown in FIG. 2A, a stable battery of the present disclosure is configured to include a base state, characterized as having a low electrochemical reactivity, and a performing state, characterized as having a much higher electrochemical reactivity. In comparison, battery materials of conventional batteries are designed for the performing state which has a much higher electrochemical reactivity, as shown in FIG. 2B, hence leading to a much more dangerous battery.

Hence, in accordance with aspects of batteries and battery cells of the present disclosure, battery materials are principally designed for the base state, rather than the performing state as conventional battery design. Since the base state has a much lower electrochemical reactivity than the performing state, battery materials selected according to the base state makes the battery much more stable, giving rise to greater safety, low degradation, and low self-discharge. Upon demand, however, a stable battery according to the present disclosure is activated, through thermal stimulation, to reach a comparable electrochemical reactivity, and hence provide sufficient power output to an external load, as a conventional, highly reactive battery (FIG. 2A). That is, batteries and battery cells according to the present disclosure are configured with much more stable and less-reactive electrode and electrolyte materials than conventional batteries, thereby resulting in higher safety.

In an implementation of the present disclosure, a battery cell is constructed with materials that are stable at ambient temperatures and with an internal resistor configured to heat the battery cell to a temperature of up to at least a performing state temperature (Tₚ) or higher. A stable battery of the present disclosure can include a variety of battery chemistries such as, but not limited to, lithium-ion, lithium-polymer, nickel-manganese-cobalt, nickel-metal hydride, lithium-sulfur, lithium-air and solid-state batteries. Such batteries are useful for consumer electronics, transportation, aerospace, military, and stationary energy storage applications.

The basic elements of a battery cell of the present disclosure include electrodes having electrode active materials (anode and cathode active materials), separators, electrolyte, a container and terminals. For example, a battery cell of the present disclosure can include an anode electrode coated on a current collector, a separator, a cathode electrode coated on another current collector and an electrolyte with one or more salts and/or one or more additives.

Lithium-ion batteries and cell can advantageously benefit from the approach of the present disclosure. A lithium-ion battery, includes one or more of anode electrodes, separators and cathode electrodes that can be in the form of sheets and either stacked up or wound in a jelly roll and packaged in a container such as a pouch cover or hard case. The container can include an electrolyte with one or more salts and/or one or more additives.

Cathode active materials useful for battery cells of the present disclosure can include, for example, lithium cobalt oxide, lithium iron phosphate, lithium manganese oxide, lithium nickel-cobalt-manganese oxides, lithium-rich layered oxides, or their mixtures, etc.

Anode active materials useful for battery cells of the present disclosure can include, for example, graphite, silicon, silicon alloys, lithium metal, lithium alloys such as lithium titanate, their mixtures, etc.

A wide variety of solvent media can be used as the electrolyte of battery cells of the present disclosure such as carbonates, ethers and acetates, for example. In one aspect of the present disclosure, the electrolyte includes one or more carbonate solvents such as dimethyl carbonate (DMC), diethyl carbonate (DEC), and ethyl methyl carbonate (EMC), ethylene carbonate (EC), propylene carbonate (PC), vinylene carbonate (VC), fluoroethylene carbonate (FEC), etc. The electrolyte can also include additives useful for forming deposits such as coatings on active electrode materials to improve the stability of the battery. Such additives include, for example, vinylene carbonate (VC), fluoroethylene carbonate (FEC), triallyl phosphate, etc.

For lithium ion battery cells, a variety of lithium salts can be added to the electrolyte such as lithium hexafluorophosphate (LiPF₆) lithium tetrafluoroborate (LiBF₄), lithium perchlorate (LiClO₄), lithium hexafluoroarsenate (LiAsF₆), lithium triflate (LiSO₃CF₃), lithium bisperfluoroethanesulfonimide (BETI) (LiN(SO₂C₂F₅)₂), etc., including mixtures thereof.

While one or more of the cathode or anode active materials and/or electrolyte materials may not be stable under certain conditions, per se, materials, including active materials for anode and cathode and the electrolyte, are constructed for low reactivity and hence stay stable and safe during off-load periods.

In accordance with an aspect of the present disclosure, a battery cell is constructed with materials that are stable at ambient temperatures. A battery according to an implementation of the present disclosure includes one or more battery cells having an internal resistor configured to heat the battery cell via power from the battery cell to at least a performing state temperature (Tₚ). Upon demand, the internal resistor heats the battery cell up to at least Tₚ at which temperature, the electrochemical reactivity of the cell is a multiple of at least 4 higher, e.g., at least 4-5 times higher, at Tₚ when compared to an electrochemical activity of the battery cell at a base state temperature (T_{b}), e.g., at a temperature of 25° C. Electrochemical activity of a battery cell can be determined by measuring internal resistance of the battery cell at discrete temperatures such as by measuring charge-transfer resistance. Charge-transfer resistance can be determined as the size of the semi-circle in electrochemical impedance spectroscopy when the battery cell is at 25° C. As an example of such a determination, see A. J. Bard and L. R. Faulkner, Electrochemical Methods, p. 386, Wiley & Sons, 2001.

In certain embodiments, battery cells of the present disclosure have one or more passivating elements, wherein the one or more passivating elements increase the charge-transfer resistance of the battery cell by at least 4 times relative to a battery cell without the one or more passivating elements. In other embodiments, battery cells of the present disclosure have one or more passivating elements, wherein the one or more passivating elements increase the direct current resistance (DCR) of the battery cell by more than 50% relative to a battery cell without one or more passivating elements,

In still further embodiments, battery cells of the present disclosure have a direct current resistance value (charge or discharge value) higher when the battery cell has a temperature of 25° C. compared to a direct current resistance value when the battery cell is at Tₚ.

The stable battery cell of the present disclosure is constructed with an internal resistor configured to heat the battery cell to a temperature of up to at least a performing state temperature (Tₚ) or higher of the battery cell. The performing state temperature (Tₚ) of a battery cell of the present disclosure is preferentially set at a temperature above typical ambient conditions such as at least 45° C., e.g., at least 50° C., 55° C., 60° C., 65° C., 70° C., 75° C., 80° C. In an embodiment of the present disclosure, Tₚ is a temperature between and including 45° C. and 65° C., such as a temperature between and including 50° C. and 60° C.

In accordance with battery cells of the present disclosure, battery power is delivered by self-heating the cell internally, e.g. to 45° C. or above, upon battery usage, and hence augments the electrochemical reactivity by several folds for power generation. Therefore, a major difference between battery cells of the present disclosure and conventional cells is separation of high battery safety and low degradation created by battery materials from high battery power by modulation of electrochemical reactivity through self-heating. Another difference is that the reactivity of electrochemical interfaces in a stable battery of the present disclosure can be actively modulated within a time period of minutes to seconds, whereas the reactivity in conventional batteries only passively evolves.

Stable battery cells of the present disclosure can be constructed in a number of ways such as by using inherently low electrochemically reactive materials, or forms of active materials that are less reactive or use of one or more passivating additives which lower electrochemical reactivity, or any combinations thereof. These low electrochemically reactive materials and passivating additives or agents are referred herein as one or more passivating elements.

The safety of the battery cell according to implementations of the present disclosure is derived from the one or more passivating elements. Power from the batteries come from temporarily boosting reaction kinetics and ion transport via internal heating. In certain aspects, the one or more passivating elements can include, for example. (a) one or more electrode active materials, e.g., cathode or anode electroactive materials, having a mean particle size larger than 20 μm, or (b) one or more electrode active materials with a Brunauer, Emmett and Teller (BET) surface area of 0.25 m²/g or less, or (c) a coating on one or more electrode active materials or (d) one or more electrode active materials with a dopant, or (e) one or more electrolyte additives that passivates one or more electrode active materials, or any combination thereof.

For example, one way to construct a stable battery cell according to the present disclosure is to form an anode having anode active material and a cathode having cathode active material, wherein the anode active material or the cathode active material or both have particles with mean particle sizes, D₅₀, that are relatively large. An active material or materials with large mean particles have lower electroactivity. For example, a mean particle size, i.e. D₅₀, for an anode or cathode active material or both can be of greater than 15 μm such as greater than 20 μm, or greater than 30 μm. A range of about 15-30 μm is about twice the mean size of active materials used in conventional batteries. Bigger particles of active materials also increase the tap density of electrodes and hence the energy density of the battery cell.

Another way to construct a stable battery cell according to the present disclosure is to form an anode electrode or cathode electrode or both with a relatively small Brunauer, Emmett and Teller (BET) surface area, such as a surface area of 0.5 m²/g or less. For example, a battery cell of the present disclosure can be constructed with an anode comprising graphite materials, which have a BET of less than 0.5 m²/g, e.g., 0.25 m²/g or less, and/or with a cathode material, such as an NMC material, having a BET of 0.25 m²/g or less than 0.25 m²/g.

In yet another way to implement a stable battery cell of the present disclosure, a battery cell can be constructed in which anode and cathode active materials have smooth primary particles without secondary pores. Such single-size powders of active materials also result in low-BET surface area. The low-BET areas and/or big sizes of anode and cathode powders reduce the electrode-electrolyte interface reactivity, and hence offer greater stability and safety for the resulting battery.

In yet another way to implement a stable battery cell of the present disclosure, a battery cell can be constructed in which an anode active material or a cathode active material or both are doped to stabilize active materials. Such dopants can include, for example, Al, Mg, Mn, Co, etc. Partial substitution of Ni by Al, Mg, Mn and Co may improve structural stabilization and thermal stability of high-capacity layered oxides by hindering the cation mixing between Ni²⁺ and Li⁺ and suppressing multiple phase transitions during charge and discharge. The layered oxides include Ni-rich oxides as well as Li-rich oxides.

In another way to implement a stable battery cell of the present disclosure, a battery cell can be constructed in which an anode active material or a cathode active material or both have surface coatings to reduce surface reactivity and therefore increase surface stability. For example, the electrolyte of the battery cell can include one or more passivating additives that can deposit or coat electrode active materials. Such solvent additives include, for example, triallyl phosphate (TAP), FEC and VC. Such salt additives include lithium bis(oxalate)borate (LiBOB), lithium difluoro oxalate borate (LiDfOB), and other preferred passivation organic salts containing boron.

In an embodiment of the present disclosure, a battery cell includes an electrolyte containing one or more of TAP, FEC, VC, etc. or combinations thereof. Such additives can be included with the electrolyte in an amount from about 0.5 wt % to about 5 wt %. Such additives can be added to form thick and robust surface films to protect anode and cathode active materials, i.e. to increase the materials' stability. Advantageously, electrolytes of the present disclosure contain lower than 20 wt % EC to further increase high-temperature chemical stability.

In another embodiment of the present disclosure, a battery cell, e.g., one or more battery cells) includes an electrolyte that undergoes a solid-to-liquid phase transformation at a temperature above about room temperature (i.e., 25° C.), e.g. above about 30° C., 35° C., 40° C., 45° C., 50° C. Preferably, such a battery cell or cells include an electrolyte that undergoes a solid-to-liquid phase transformation at a temperature above about 25° C. but less than a performing state temperature (Tₚ) of the battery cell or cells. For example, the electrolyte in one or more cells or in all cells of a battery can undergo a solid-to-liquid phase transformation at a temperature from about 25° C. to about 65° C., such as from about 25° C., 30° C., 35° C., 40° C. to about 45° C., 50° C., 60° C., 65° C., 70° C., 75° C., 80° C. and values therebetween. For instance, ethylene carbonate (EC) has a melting point around 35° C. An electrolyte having a high percentage of EC can be a solid at room temperature and exhibits low ionic conductivity for high physical stability, but can change to a liquid at an operating temperature of the cell, e.g., 60° C. or higher and hence exhibits high ionic conductivity for high power output.

In addition, the amount of salt used with the electrolyte can be adjusted to increase the stability of the battery cell. For example, electrolytes can be highly concentrated with a salt concentration of greater than 4 mole per liter (4 M). In a highly concentrated electrolyte (e.g., greater than about 4M), there is little or no free solvent molecules available to react with lithium ions; as such, these highly concentrated electrolytes are much more thermally stable than dilute electrolytes with 1 or 1.2M salt.

In another aspect of the present disclosure, the electrolyte is a polymer electrolyte, a sulfide electrolyte, or an oxide electrolyte. In one more embodiment, the electrolyte is an ionic liquid.

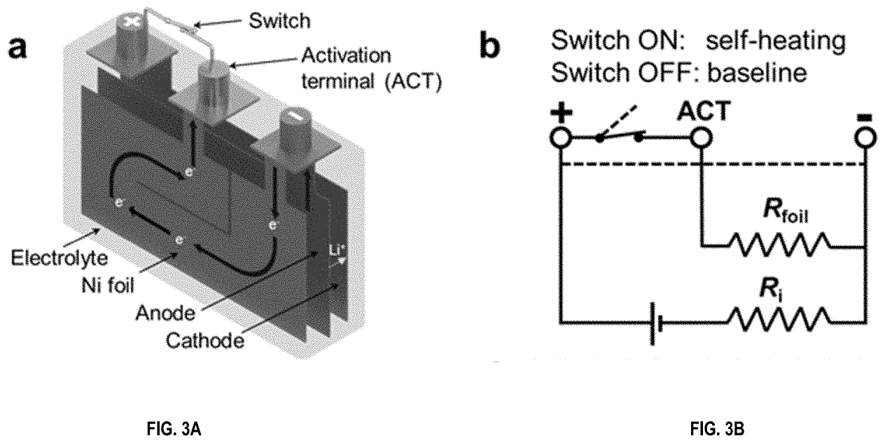

The high power output of the stable battery of the present disclosure is provided by increasing electrochemical activity of the battery through thermal stimulation. FIG. 3A schematically illustrates an internal resistor configured to heat the battery cell in accordance with one implementation of the present disclosure. As shown in the particular implementation of FIG. 3A, the battery cell comprises of a resistor sheet (e.g., a nickel foil) with two tabs inserted in the middle of an electrode-separator assembly. One tab of the resistor sheet is electrically connected to a negative terminal, whereas the other tab is electrically connected to an activation terminal which in turn is electrically connected to a switch which in turn is electrically connected to a positive terminal. In addition, the switch can be located with the heating element inside a battery cell. The battery cell further includes a cathode electrode electrically connected to the positive terminal and an anode electrode electrically connected to the negative terminal and an electrolyte housed in a casing. The cell would further include a separator between the electrodes, which is not shown for illustrative convenience. An electrical circuit of the configuration of the battery cell of FIG. 3A is schematically shown in FIG. 3B.

The negative and positive terminals can be electrically connected to an external circuit, e.g., an external load, to power an external load upon demand. In operation, when the battery temperature is below Tₚ, the switch is turned on and battery power (e.g., current from the battery cell) will flow through the resistor sheet causing the resistor sheet to heat up which in turn rapidly heats other battery cell components, e.g., electrolyte, electrodes, etc. Once the battery cell reaches a temperature of close to Tₚ, or preferably at or above Tₚ, the battery has sufficient electrochemical activity to power an external load and is electrically connected to an external load. The switch is then turned off and heat generated from normal battery operations maintains the temperature of the battery at or above its performance temperature. Prior to the temperature of the battery cell reaching Tₚ, the battery cell has insufficient power to an external load in certain embodiments.

In an embodiment of the present disclosure, the heating element comprises one or more resistor sheet inside a battery cell (exposed to the electrolyte). The resistor sheet preferably has a resistance in units of Ohm equal to the numerical value of between 0.1 to 5 divided by the battery's capacity in Amp-hours (Ah), e.g. between about 0.5 to 2 divided by the battery's capacity in Ah. For example, the resistor sheet for a 20 Ah battery is preferably between about 0.005 Ohm (0.1 divided by 20) to about 0.25 Ohm (5 divided by 20), e.g. between about 0.025 Ohm (0.5 divided by 20) to about 0.1 Ohm (2 divided by 20).

The resistor sheets of the present disclosure can be made of, for example, graphite, highly ordered pyrolytic graphite (HOPG), stainless steel, nickel, chrome, nichrome, copper, aluminum, titanium, or combinations thereof. In certain embodiments, the resistor sheet of the present disclosure is preferably flat with a large surface area so that it can have good thermal communication with battery components. The resistor sheets of the present disclosure can have a thickness between about 1 micrometer and about 200 micrometers with a preferred range of about 5 to about 100 micrometers. Resistor sheets that have large electrical resistance, high thermal conductivity, and low cost are useful for certain embodiments of the present disclosure.

The resistance of the resistor sheet can be adjusted by patterning the sheet, i.e., removing material from the resistor sheet. Patterning allows a resistor sheet to have a sufficient thickness for mechanical strength and weldability but a reduced resistance. Patterns with rounded corners have the advantage of reducing temperature build-up at the corner of a pattern. Patterned resistor sheets can be manufactured by photo etching, electrical discharge machining, water jet cutting, laser cutting, stamping, etc.

In some embodiments, a substantial portion of the surface of a resistor sheet can be coated to minimize undesired chemical reactions or electrical connection with an electrolyte. The protective coating should be thermally conductive, electrically insulating, and chemically stable within a battery cell. Such a coating can comprise polymers, metal oxides, and others. Examples of polymer materials for the protective coating include: polyethylene, polypropylene, chlorinated polypropylene, polyester, polyimide, PVDF, PTFE, nylon, or co-polymers thereof or combinations thereof. Examples of metal oxide materials for the protective coating include oxides of Mg, Al, Ti, V, Cr. Mn, Fe, Co, Ni, Cu, Zn, and combinations thereof. The protective coating is preferred to have a high dielectric constant. In some embodiments, adhesive may be used between resistor sheets and protective coating. The thickness of the protective coating may be between 10 nm to 100 um, preferably 10 nm to 50 μm. The coating should be thin enough to allow good heat transfer but impervious to protect the resistor sheet from contact with the electrolyte inside a battery cell. The protective coating may be applied onto resistor sheets by such methods as taping, laminating, dip coating, spin coating, spraying coating, chemical vapor deposition, atomic layer deposition, solution casting, electrodeposition, self-assembled monolayer, stereolithography, surface oxidation, and others.

The internal resistor configured to heat the battery cell via power from the battery cell can include a switch which can be composed of an electromechanical relay and a temperature controller, or a solid-state relay with a temperature sensor, a power MOSFET (metal oxide semiconductor field effect transistor) with a temperature sensor, a high-current switch with a temperature sensor, or an IGBT (insulated-gate bipolar transistor). The switch of the present disclosure can be placed inside or outside a battery cell. In a case when the switch is located inside a battery cell, the switch, e.g. a MOSFET, can be integrated with the resistor sheet to form a flat substrate with a gate wire led out of the battery cell to control the switch from the outside of the battery cell.

The switch of the present disclosure can be activated to pre-heat a battery cell from room temperature initially. This is preferred in concert with the use of more stable electrode and electrolyte materials. This is because stable battery materials having low reactivity can be augmented at elevated temperatures to yield high reactivity for sufficient power generation.

The heating rate of an internal resistor configured to heat the battery cell via power from the battery cell is preferred to be at least 5° C./min, more preferred to be at least 10° C./min, such as at least 20, 40, 50, 100, and 200° C./min. For example, for a 20° C. temperature rise prior to usage, it takes less than 4 minutes of heating when the internal resistor is configured with a heating rate of 5° C./min. Such a time period generally has a minimal impact on convenience of using such a battery for many applications.

Another aspect of the present disclosure involves a method of using a stable battery cell. Such a method includes a battery cell having an internal resistor configured to heat the battery cell via power from the battery cell and an operation to heat such a battery cell to at least a performing state temperature (Tₚ) when the battery cell is below Tₚ. Such an operation can be achieved, for example, by activating a switch as illustrated in FIG. 3A. In this configuration, the battery cell powers the resistor sheet with power from the battery cell itself to heat the battery cell.

Another operation of a method of the present disclosure includes powering an external load electrically connected to the battery cell via the battery cell while a temperature of the battery cell is at least Tₚ or higher. Operating the battery cell generates heat and this heat can be used to maintain the temperature of the battery at or above Tₚ. Hence, additional methods of operating a battery cell of the present disclosure can further include de-activating the internal resistor configured to heat the battery cell when the battery cell temperature is at or above Tₚ. Such an operation will cool the battery cell below Tₚ and is implemented when the battery cell is not powering an external load.

In certain implementations of battery cells of the present disclosure, the battery cell has insufficient electrochemical activity to power an external load except when below Tₚ. As such, battery cells of the present disclosure are inherently safer when not in use. As explained earlier, battery cells of the present disclosure have an electrochemical activity of at least 4 times higher at Tₚ when compared to an electrochemical activity of the battery cell at a temperature of about 25° C.

In certain embodiments, the performance temperature of a battery cell of the present disclosure is preferentially set at a temperature above typical ambient conditions such as at least 45° C., e.g., at least 50° C., 55° C., 60° C., 65° C. In an embodiment of the present disclosure, Tₚ is a temperature between and including 45° C. and 65° C., such as a temperature between and including 50° C. and 60° C.

Hereinafter, the present invention is explained by the following Examples and Test Examples in more detail. The following Examples and Test Examples are intended to further illustrate the present invention, and the scope of the present invention cannot be limited thereby in any way.

### EXAMPLES

Several pouch cells with a capacity of about 2.8 Ah were assembled using LiNi_{0.6}Co_{0.2}Mn_{0.2}O₂ (NMC622) as cathode active material and graphite as anode active material. The capacity ratio of negative to positive electrode, or NP ratio, was kept at 1.2. Each 2.8 Ah pouch cell contained a stack of 21 anode layers and 20 cathode layers. A Celgard-2325 separator of 25 μm in thickness was used between electrode layers. The loadings of NMC622 in the positive electrode and graphite in the negative electrode were 10.5 and 6.6 mg/cm², respectively. The cathodes were prepared by coating a slurry containing N-methylpyrrolidone (NMP) solvent onto 15 m thick Al foil. The slurry included, on a dry weight bases, NCM622 (91.5 wt. %), Super-P (Timcal) (4.1 wt. %) and polyvinylidene fluoride (PVdF, available from Arkema) (4.4 wt. %) as a binder. The anodes were prepared by coating a deionized (DI) water-based slurry onto 10 m thick Cu foil, whose dry material included graphite (95.4 wt. %), Super-P (1.0 wt. %), styrene-butadiene rubber SBR (Zeon) (2.2 wt. %) and CMC (Dai-Ichi Kogyo Seiyaku) (1.4 wt. %). Each pouch cell has a 110×56 mm footprint area, weighed 68 g, and had a 2.8 Ah nominal capacity with specific energy of 150 Wh/kg and energy density of 310 Wh/L.

### Comparative Example

As a comparative example, several of the pouch cells described above were filled with 1 M LiPF₆ dissolved in EC/EMC (3:7 by wt.)+2% VC as electrolyte, which is a common electrolyte currently used in electric vehicle batteries.

Examples 1 and 2 use 1M LiPF₆ dissolved in a mixture of EC/FEC/EMC+2% VC, with 1-2 wt. % triallyl phosphate (TAP) added as the additive. Specifically, battery cells for Example 1 were prepared with 1M LiPF₆ in EC/EMC (1/9 wt.)+2% VC+1% TAP, and battery cells for Example 2 were prepared with 1M LiPF₆ in EC/EMC (1/9 wt.)+2% VC+3% FEC+1% TAP. Both examples 1 and 2 contain less than 20% EC so as to make the electrolytes more tolerant to elevated temperatures because at high temperatures lattice oxygen tends to release from NMC cathode materials and reacts with EC to yield CO₂, CO and H₂O. On the other hand, a certain amount of EC is necessary to form a robust solid-electrolyte interphase (SEI) layer on graphite to protect anode active material. Preferably, the EC amount is equal to or less than 10 wt %. FEC is known to increase the thermal stability towards charged electrodes and is good to form resilient SEI layer on graphite anode so as to further stabilize the anode/electrolyte interface. Polymerization of triallyl phosphate, as an electrolyte additive, forms thick solid-electrolyte interphase films at the surface of the NMC positive electrode, blocking the solvent to contact NMC material and hence increasing the interfacial stability.

Performance and diagnostic testing of the cells in the comparative example and examples 1 and 2 were carried out at different temperatures and various C-rates. Cycle aging tests of the pouch cells were performed using a LAND battery testing system. A forced-air oven was used to control different ambient temperatures. For each aging cycle, the cell was charged to 4.2 V at a constant current of 2 A (1 C-rate) and then charged at a constant voltage of 4.2 V until the current decreased to 0.1 A (C/20). After a rest of 5 minute, the cell was discharged to 2.8 V at constant current of 2 A (1 C-rate). Then it is another rest for 5 minutes. When the aging cycle number reach a specific value (e.g. 400, 1000 cycles), the cell was cycled at charge and discharge rate of C/3 to determine cell's capacity (donated as C/3 capacity). For impedance tests at different temperatures, the cells were fully charged and then discharged to 90% SOC at C/3-rate. Impedance test was performed with an AC voltage amplitude of 5 mV in the frequency range of 50 kHz to 0.005 Hz. For DCR test, the cells were fully charged and then discharged to 50% SOC at C/3-rate. Discharge rate of 5 C and charge rate of 3.75 C were used to determine the values of direct-current resistance DCRdis during discharge and DCRch during charge.

Calendar aging tests were performed at different ambient temperatures and state-of-charge (SOC). The forced-air oven was used to control different ambient temperatures. The cell voltage was kept constant by LAND instrument battery testing system. The voltage was related to SOC. When the calendar aging time reach a specific value (e.g. 25, 60, 100 days), the cell was cycled at charge and discharge rate of C/3 to determine cell's capacity. Then impedance tests of the pouch cells were performed with an AC voltage amplitude of 5 mV in the frequency range of 50 kHz to 0.005 Hz at room temperature. The DCR test for the calendar-aged cells was the same as that for cycle-aged cells.

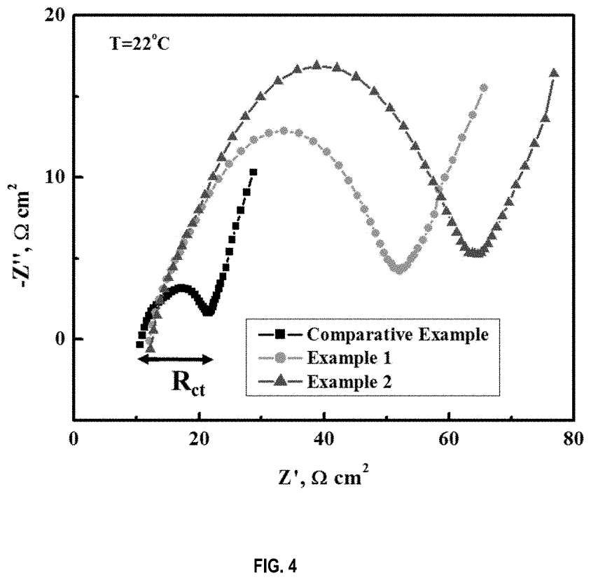

FIG. 4 shows the charge-transfer resistances of new batteries. The charge-transfer resistance is equivalent to the inverse of electrochemical activity of a battery cell. As observed in the figure, the charge-transfer resistance of cells of Examples 1 and 2 was about 4-5 times of cells prepared for the comparative example. Specifically, Examples 1 and 2 have charge-transfer resistances in the range of 40-55 Ohm*cm² or equivalently 0.085-0.13 Ohm*Ah. The battery cell of the comparative example had a charge-transfer resistances of 10 Ohm*cm². This indicates that the new batteries, Examples 1 and 2, are much more stable at room temperature.

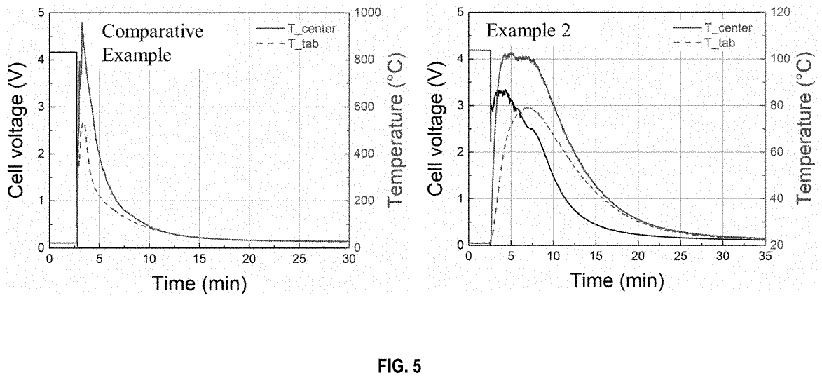

As a result, the nail penetration test results of the comparative example and example 2, evident from FIG. 5, are totally different, with the cell temperature reaching about 1,000° C. in the comparative example but less than 100° C. in example 2. These nail penetration results clearly show that the stable battery according to aspects of the present disclosure, i.e. Example 2, is much safer than the comparative example.

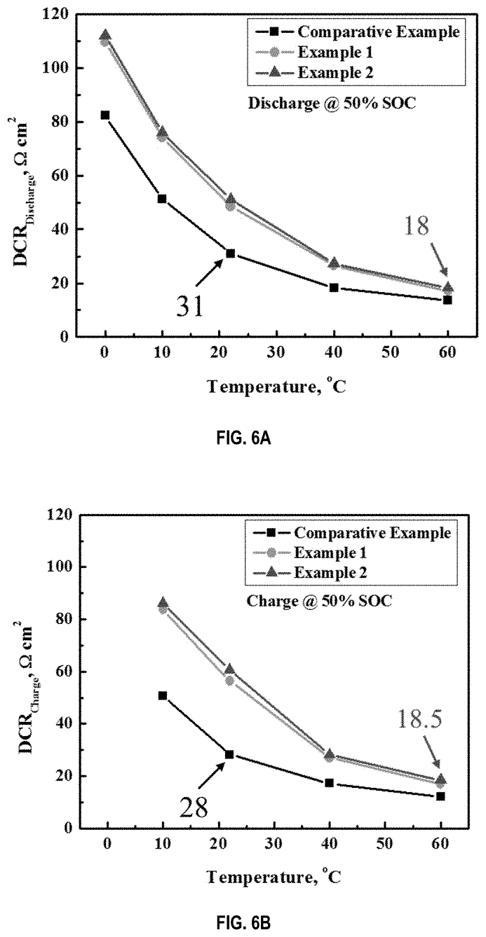

FIGS. 6A and 6B compare direct current resistances (DCR) of discharge and charge at 50% state of charge for batteries of the comparative example, Examples 1 and 2 as function of temperatures. The DCR of discharge for the comparative example is 31 Ohm*cm² at the operation temperature of 22° C., a close approximation of room temperature 25° C. In comparison, the DCR for example 2 is 18 Ohm*cm² at the operation temperature of 60° C. Since discharge power is inversely proportional to the DCR, it follows that the discharge power of Example 2 is 172% of that of the comparative example. Similarly, the charge power of Example 2 is about 152% of the comparative example. (I.e., the DCR of charge for the comparative example is 28 Ohm*cm² at the operation temperature of 22° C. whereas the DCR for Example 2 is 18.5 Ohm*cm² at the operation temperature of 60° C.) These results clearly demonstrate that by operating the example 2 battery at the elevated temperature of 60° C., both discharge and charge power are greater than those of the comparative example operated at room temperature.

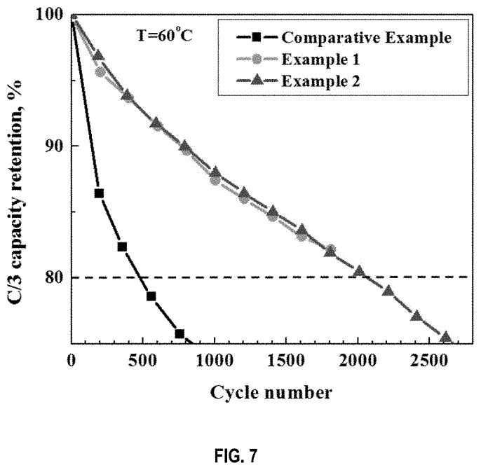

FIG. 7 compares capacity retention of the comparative example with examples 1 and 2 during cycling at 60° C. of 1 C charge to 4.2V CCCV till C/20 and then 1 C discharge to 2.8V. Clearly, the comparative example suffers 20% capacity loss at less than 500 cycles, while Example 2 can achieve more than 2,000 cycles before reaching 20% capacity loss. The stability and long cycle life of example 2 battery of this invention are therefore clearly demonstrated.

In summary, the stable batteries of this invention, i.e. Examples 1 and 2, as shown in FIGS. 6A and 6B, can deliver 72% and 52% more power during discharge and charge, respectively, than the comparative example of prior art. Simultaneously, the safety and cyclability of Examples 1 and 2 are much better than the comparative example of conventional battery cells as shown in FIGS. 5 and 7, respectively.

Only the preferred embodiment of the present invention and examples of its versatility are shown and described in the present disclosure. It is to be understood that the present invention is capable of use in various other combinations and environments and is capable of changes or modifications within the scope of the inventive concept as expressed herein. Thus, for example, those skilled in the art will recognize, or be able to ascertain, using no more than routine experimentation, numerous equivalents to the specific substances, procedures and arrangements described herein. Such equivalents are considered to be within the scope of this invention, and are covered by the following claims.

What is claimed is:

1. A battery cell having an internal resistor configured to heat the battery cell via power from the battery cell to at least a performing state temperature (Tₚ) and having one or more passivating elements, wherein the one or more passivating elements increase the charge-transfer resistance of the battery cell by at least 4 times relative to a battery cell without the one or more passivating elements, wherein the charge-transfer resistance is determined by electrochemical impedance spectroscopy when the battery cell is at 25° C.

2. The battery cell according to claim 1, wherein the one or more passivating elements include: (a) one or more electrode active materials having a mean particle size larger than 20 μm, or (b) one or more electrode active materials with a Brunauer, Emmett and Teller (BET) surface area of 0.25 m²/g or less, or (c) a coating on one or more electrode active materials or (d) one or more electrode active materials with a dopant, or (e) one or more electrolyte additives that passivates one or more electrode active materials, or any combination thereof.

3. The battery cell according to claim 1, wherein the battery cell comprises an anode having anode active material and a cathode having cathode active material and wherein the anode active material or the cathode active material or both have particles with average particle sizes, D₅₀, of greater than 20 μm.

4. The battery cell according to claim 1, wherein the battery cell comprises an anode having anode active material and a cathode having cathode active material and wherein the anode active material or the cathode active material or both have a Brunauer, Emmett and Teller (BET) surface area of 0.25 m²/g or less.

5. The battery cell according to claim 4, wherein the cathode active material includes NMC and the cathode active material has a BET surface area of 0.25 m²/g or less.

6. The battery cell according to claim 5, wherein the anode active material comprises graphite.

7. The battery cell according to claim 1, wherein the battery cell comprises an anode having an anode active material and a cathode having cathode active material and wherein the anode active material or the cathode active material or both have smooth primary particles without secondary pores.

8. The battery cell according to claim 1, wherein the battery cell comprises an anode having an anode active material and a cathode having cathode active material and wherein the anode active material or the cathode active material or both have a coating on surfaces thereof which increases the charge-transfer resistance of the battery cell by at least 4 times relative to a battery cell without the coating.

9. The battery cell according to claim 1, wherein the battery cell comprises an anode having an anode active material and a cathode having cathode active material and one or more electrolyte additives in sufficient quantity to deposit on a surface of an electrode active material and to increase the charge-transfer resistance of the battery cell by at least 4 times relative to a battery cell without the one or more electrolyte additives.

10. The battery cell according to claim 9, wherein the electrolyte additive includes TAP.

11. The battery cell according to claim 1, wherein the battery cell comprises an electrolyte containing less than 20 wt % EC.

12. The battery cell according to claim 1, wherein the battery cell comprises an electrolyte containing a salt at a concentration of greater than 4 mole per liter.

13. The battery cell according to claim 1, wherein the battery cell comprises a polymer electrolyte, a sulfide electrolyte, or an oxide electrolyte.

14. The battery cell according to claim 1, wherein the battery cell comprises an electrolyte including an ionic liquid.

15. The battery cell according to claim 1, wherein the battery cell comprises an electrolyte that undergoes a solid-to-liquid phase transformation at a temperature from about 25° C. to about 80° C.

16. The battery cell according to claim 1, wherein the internal resistor is configured to heat the battery cell at a rate of at least 5° C./min.

17. The battery cell according to claim 1, wherein Tₚ is at least 45° C.

18. A method of operating a battery cell according to claim 1, the method comprising:
internally heating the battery cell to Tₚ when a temperature of the battery cell is below Tₚ; and
powering an external load via the battery cell while a temperature of the battery cell is at Tₚ or higher.

19. The method of claim 18, comprising internally heating the battery cell at a rate of at least 5° C./min.

20. The method of claim 18, further comprising cooling the battery cell below Tₚ, when the battery cell is not powering an external load.
